(19) United States
(12) Patent Application Publication
(10) Pub. No.: US 2004/0042467 A1
(43) Pub. Date: Mar. 4, 2004

(54) Method to improve fax transmission quality over packet based networks with high packet jitter by means of sending "Fill" at the end of a scan line

(76) Inventors: Mehrdad Abrishami, Gaithersburg, MD (US); Jianwei Bei, Rockville, MD (US)

Correspondence Address: LSI LOGIC CORPORATION, 1621 BARBER LANE, MS: D-106 LEGAL, MILPITAS, CA, 95035, US

(21) Appl. No.: 10/229,967

(22) Filed: Aug. 28, 2002

(51) Int. Cl. H04L 12/28; H04J 3/06

(52) U.S. Cl. 370/401; 370/516

(57) ABSTRACT

A method and apparatus to improve fax quality when transmitting fax over packet based network with significant packet jitter or loss. In non-ECM mode, the method is based on insertion of “Fill” at the end of a data scan line and prior to the End-Of-Line (EOL) in order to maintain data transmission continuity toward a receiving fax machine. The insertion of “Fill” is applied when operating Facsimile transmission over Internet to increase the success rate for transmission of facsimile via T.38 or similar Facsimile relay protocols. The method ensures that network delay, packet jitter or loss do not result in violation of the T.30 protocol when transmitting data toward the receiving fax machine. An alternative method is also provided for ECM mode where HDLC flags are inserted instead of “Fill.”

### BACKGROUND

The present invention generally relates to fax transmissions over packet based networks, and more specifically relates to a method and apparatus for maintaining a fax transmission over a communications path that includes a narrowband Network, by transmitting “Fill” at the end of a T.4 encoded scan line in non-ECM mode. In ECM mode, HDLC flags are inserted between the HDLC frames. In particular, the present invention relates to a method and apparatus for maintaining a facsimile transmission even though a data bottleneck exists somewhere between a source and destination fax machine, which might otherwise cause the fax transmission to cease due to excessive time delay brought about by the bottleneck.

In its T.30 and T.4 standards, the Telecommunications Standardization Section of the ITU (ITU-T) has defined procedures for facsimile transmission of documents in a public switched telephone network (PSTN). The T.30 and T.4 standards define a Group 3 facsimile service, also known as Group 3 FAX and G3 FAX. The recommendation is for a “Group 3 facsimile apparatus.” A Group 3 facsimile apparatus includes any one of (1) a facsimile machine, (2) a computer with a facsimile modem and corresponding software, and (3) other similar products. As referred to herein, the term “facsimile machine” or “fax machine” applies to any Group 3 facsimile apparatus.

The T.30 standard was written for a facsimile provided over a wired telephone network, a PSTN, or a digital encoding of the analog signal (e.g., using PCM). However, in a bandwidth-limited digital network or a packet network such as the Internet, other techniques are used to send a facsimile in real-time.

One method of supporting Group 3 FAX over bandwidth-limited digital network or a packet network, such as Internet, uses a facsimile relay system to (1) demodulate the analog facsimile signal, (2) transmit the digital data using the digital network or packet network, and (3) remodulate the signal at the other relay station to provide an analog signal. In such a system, in addition to demodulating and remodulating the facsimile signal, the T.30-based relay protocol is implemented in the relay gateways. ITU-T T.38 is one such T.30-based relay protocol specified for the IP network. T.38 specifies the messages and data exchanged between facsimile gateways connected via an IP network. Excessive jitter in the arrival time of the demodulated fax data by the receiving Gateway or loss of the packets in the network may result in an under run of the buffers employed to compensate for the network packet jitter. This under run may result in transmission of incorrect data toward the receiving fax machine.

### OBJECTS AND SUMMARY

A general object of an embodiment of the present invention is to provide a method and apparatus to improve fax quality when transmitting fax over packet based network with significant packet jitter or loss.

Another object of an embodiment of the present invention is to provide a method and apparatus for ensuring that network delay, packet jitter or loss do not result in violation of the T.30 protocol when transmitting data toward the receiving fax machine.

Still another object of an embodiment of the present invention is to provide a method and apparatus for maintaining a fax transmission even though a bottleneck exists somewhere between a source and destination fax machine, which might otherwise cause the fax transmission to cease due to excessive time delay brought about by the bottleneck.

Briefly, and in accordance with at least one of the foregoing objects, an embodiment of the present invention provides a method and apparatus for maintaining a fax transmission over a communications path that includes a narrowband network, either by transmitting “Fill” at the end of a T.4 encoded scan line (in non-ECM mode) or by inserting HDLC flags between HDLC frames (in ECM mode).

### BRIEF DESCRIPTION OF THE DRAWINGS

The organization and manner of the structure and operation of the invention, together with further objects and advantages thereof, may best be understood by reference to the following description, taken in connection with the accompanying drawings, wherein:

FIGS. 1 and 2 show a packet based network, wherein two Group 3 facsimile devices are communicating through gateways; and

FIG. 3 is a flow chart which illustrates a method which is in accordance with an embodiment of the present invention.

### DESCRIPTION

While the invention may be susceptible to embodiment in different forms, there are shown in the drawings, and herein will be described in detail, specific embodiments with the understanding that the present disclosure is to be considered an exemplification of the principles of the invention, and is not intended to limit the invention to that as illustrated and described herein.

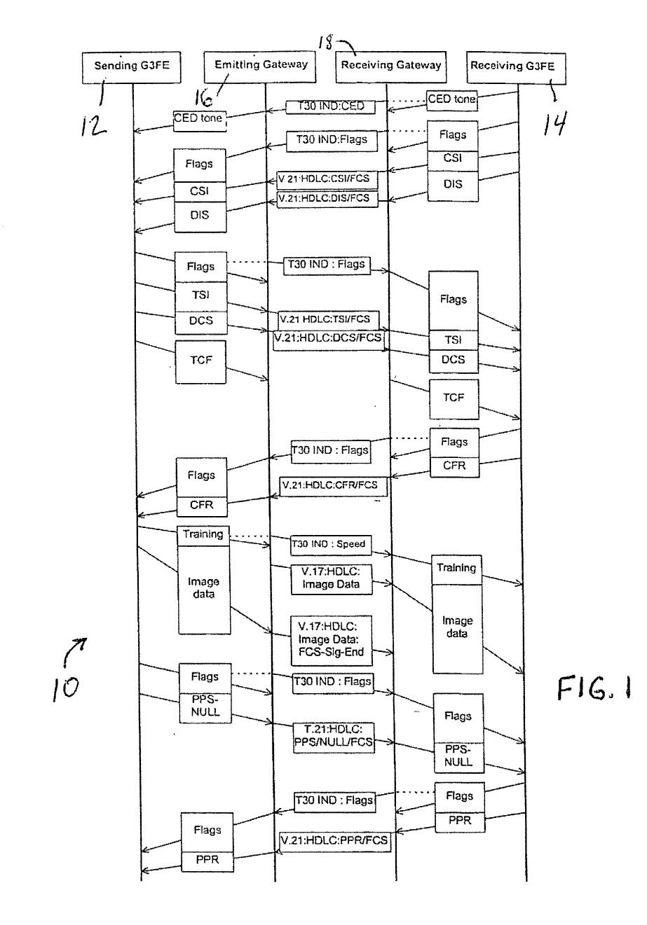

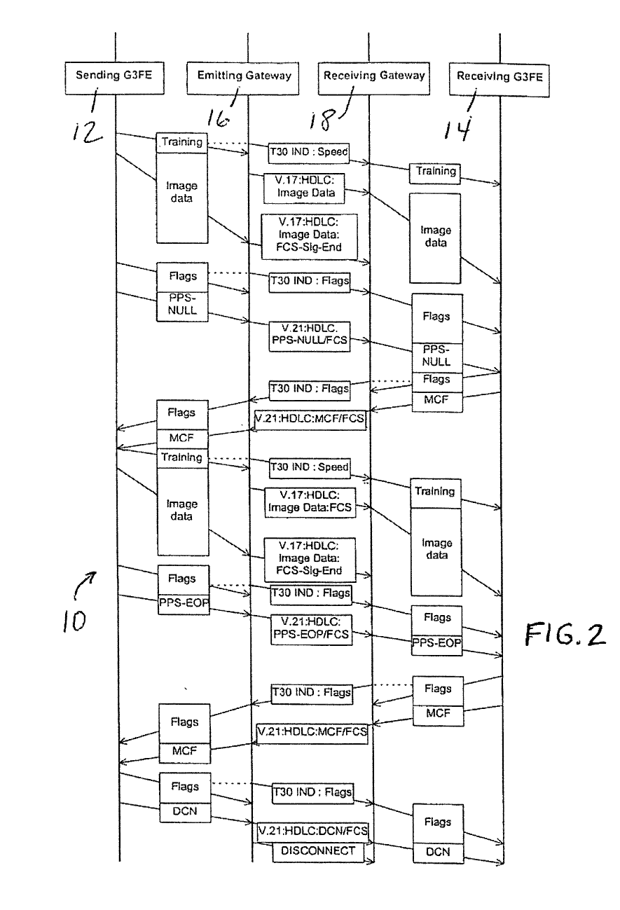

FIGS. 1 and 2 illustrate messages being transmitted in a packet based network 10 between two G3FE's, i.e. between a sending G3FE 12 or sending facsimile equipment and a receiving G3FE 14 or receiving facsimile equipment. The messages are communicated through gateways, and FIGS. 1 and 2 illustrate an emitting or peer gateway 16 and a receiving gateway 18.

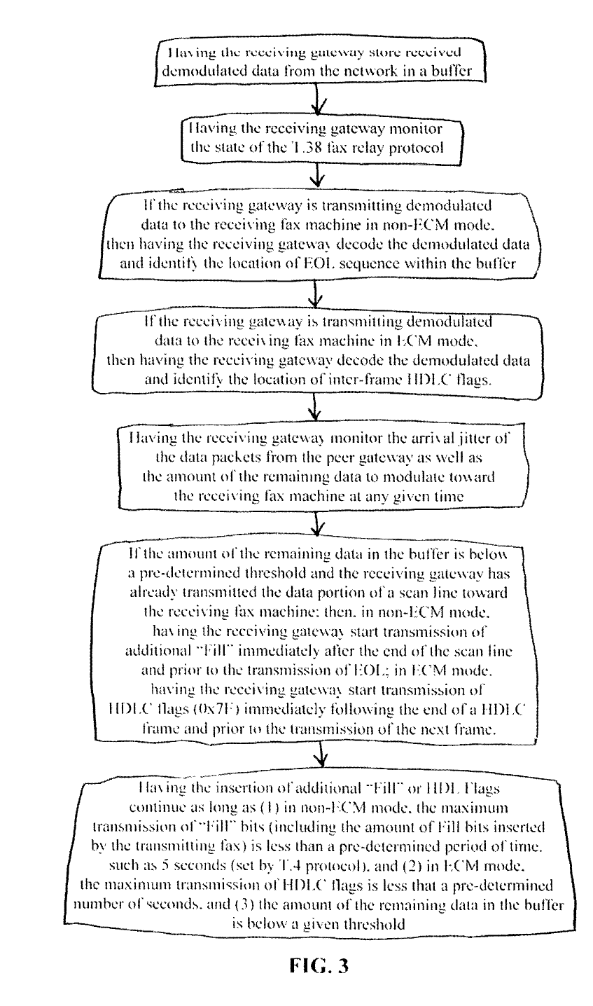

The T.38 defines the procedures to allow G3 facsimile transmission between terminals where, in addition to the PSTN, a portion of the transmission path used between terminals includes an IP network, e.g. the Internet. T.38 specifies the messages and data exchanged between facsimile gateways connected via an IP network. In the real-time facsimile transmission of Group 3 over Internet (or a packet network with variable delay), it is possible for packets to be lost or arrive late. In that case, it is possible to compensate for the loss or late arrival of page data by using a method and apparatus which is in accordance with an embodiment of the present invention. Specifically, one preferred embodiment of the present invention provides a method which is illustrated in FIG. 3, wherein the method provides that: 1. The receiving Gateway stores the received demodulated data from the network in a buffer.

2. The receiving Gateway monitors the state of the T.38 fax relay protocol.

3. If the receiving Gateway is transmitting demodulated data to the receiving fax machine in non-ECM mode, then the receiving Gateway decodes the demodulated data and identifies the location of EOL sequence within the buffer.

4. If the receive Gateway is transmitting demodulated data to the receiving fax machine in ECM mode, then the receiving Gateway decodes the demodulated data and identifies the location of inter-frame HDLC flags.

5. The receiving Gateway monitors the arrival jitter of the data packets from the peer Gateway as well as the amount of the remaining data to modulate toward the receiving fax machine at any given time.

6. If the amount of the remaining data in the buffer is below a given threshold and the Gateway has already transmitted the data portion of a scan line toward the receiving fax machine. Then in non-ECM mode, the Gateway starts transmission of additional “Fill” immediately after the end of the scan line and prior to the transmission of EOL. In ECM mode, the Gateway starts transmission of HDLC flags (0x7E) immediately following the end of a HDLC frame and prior to the transmission of the next frame. p1 7. The insertion of the additional “Fill” or HDLC Flags, continues as long as (1) in non-ECM mode, the maximum transmission of “Fill” bits (including the amount of Fill bits inserted by the transmitting fax) is less than a pre-determined period of time, such as 5 seconds (set by T.4 protocol), and (2) in ECM mode, the maximum transmission of HDLC flags is less than a pre-determined number of seconds, and (3) the amount of the remaining data in the buffer is below a given threshold.

Another embodiment of the present invention provides a receiving gateway which is configured consistent with the above-described method. Still another embodiment of the present invention provides a network which includes such a receiving gateway.

The present invention may be used in, for example, the following applications/environment: voice over IP applications, compressed networks over E1/T1, satellite communications—VSATs, voice over cable modems, and other packet based networks.

While embodiments of the present invention are shown and described, it is envisioned that those skilled in the art may devise various modifications of the present invention without departing from the spirit and scope of the appended claims.

What is claimed is:

1. A method to improve fax quality when transmitting fax over a packet based network, wherein the packet based network includes a receiving gateway in communication with receiving facsimile equipment, said method comprising:
having the receiving gateway store received demodulated data from the network in a buffer; having the receiving gateway monitor a state of a fax relay protocol; having the receiving gateway decode the demodulated data;
at least one of having the receiving gateway identify the location of an End Of Line (EOL) sequence within the buffer and having the receiving gateway identify the location of inter-frame HDLC flags; and at least one of having the receiving gateway start transmission of a “Fill” immediately after the end of a scan line and prior to transmission of EOL and having the receiving gateway start transmission of HDLC flags immediately following the end of a HDLC frame and prior to transmission of the next frame.

2. A method as recited in claim 1, further comprising having the receiving gateway transmit demodulated data to the receiving facsimile equipment in non-ECM mode.

3. A method as recited in claim 2, further comprising having the receiving gateway transmit demodulated data to the receiving facsimile equipment in ECM mode.

4. A method as recited in claim 1, wherein the network includes a peer gateway in communication with the receiving gateway, said method further comprising having the receiving gateway monitor the arrival jitter of data packets received from the peer gateway.

5. A method as recited in claim 4, further comprising having the receiving gateway monitor the amount of remaining data to modulate toward the receiving facsimile equipment.

6. A method as recited in claim 1, wherein the step of having the receiving gateway start transmission of a “Fill” immediately after the end of a scan line and prior to transmission of EOL, further comprises having the receiving gateway start transmission of the “Fill” once the amount of the remaining data in the buffer is below a pre-determined threshold and the receiving gateway has already transmitted the data portion of a scan line toward the receiving facsimile equipment.

7. A method as recited in claim 1, further comprising having the receiving gateway continue transmission of “Fill” until the maximum transmission of fill bits is less than a pre-determined time period.

8. A method as recited in claim 1, further comprising having the receiving gateway continue transmission of “Fill” until the maximum transmission of fill bits is less than a pre-determined time period and the amount of remaining data in the buffer is below a pre-determined threshold.

9. A method as recited in claim 8, wherein the step of having the receiving gateway start transmission of HDLC flags immediately following the end of a HDLC frame and prior to transmission of the next frame, further comprises having the receiving gateway start transmission of HDLC flags once the amount of the remaining data in the buffer is below a pre-determined threshold and the receiving gateway has already transmitted the data portion of a scan line toward the receiving facsimile equipment.

10. A method as recited in claim 1, further comprising having the receiving gateway continue transmission of HDLC flags until the maximum transmission of HDL flags is less than a pre-determined time period.

11. A method as recited in claim 1, further comprising having the receiving gateway continue transmission of HDLC flags until the maximum transmission of fill bits is less than a pre-determined time period and the amount of remaining data in the buffer is below a pre-determined threshold.

12. A method to improve fax quality when transmitting fax over a packet based network, wherein the packet based network includes a receiving gateway in communication with receiving facsimile equipment, said method comprising:
having the receiving gateway store received demodulated data from the network in a buffer; having the receiving gateway decode the demodulated data; having the receiving gateway identify the location of an End Of Line (EOL) sequence within the buffer; and having the receiving gateway start transmission of a “Fill” immediately after the end of a scan line and prior to transmission of EOL.

13. A method as recited in claim 12, further comprising having the receiving gateway transmit demodulated data to the receiving facsimile equipment in non-ECM mode.

14. A method as recited in claim 12, wherein the network includes a peer gateway in communication with the receiving gateway, said method further comprising having the receiving gateway monitor the arrival jitter of data packets received from the peer gateway.

15. A method as recited in claim 14, further comprising having the receiving gateway monitor the amount of remaining data to modulate toward the receiving facsimile equipment.

16. A method as recited in claim 15, wherein the step of having the receiving gateway start transmission of a “Fill” immediately after the end of a scan line and prior to transmission of EOL, further comprises having the receiving gateway start transmission of the “Fill” once the amount of the remaining data in the buffer is below a pre-determined threshold and the receiving gateway has already transmitted the data portion of a scan line toward the receiving facsimile equipment.

17. A method as recited in claim 12, further comprising having the receiving gateway continue transmission of “Fill” until the maximum transmission of fill bits is less than a pre-determined time period.

18. A method as recited in claim 12, further comprising having the receiving gateway continue transmission of “Fill” until the maximum transmission of fill bits is less than a pre-determined time period and the amount of remaining data in the buffer is below a pre-determined threshold.

19. A method to improve fax quality when transmitting fax over a packet based network, wherein the packet based network includes a receiving gateway in communication with receiving facsimile equipment, said method comprising: having the receiving gateway store received demodulated data from the network in a buffer; having the receiving gateway monitor a state of a fax relay protocol; having the receiving gateway decode the demodulated data; having the receiving gateway identify the location of inter-frame HDLC flags; and having the receiving gateway start transmission of HDLC flags immediately following the end of a HDLC frame and prior to transmission of the next frame.

20. A method as recited in claim 19, further comprising having the receiving gateway transmit demodulated data to the receiving facsimile equipment in ECM mode.

21. A method as recited in claim 19, wherein the network includes a peer gateway in communication with the receiving gateway, said method further comprising having the receiving gateway monitor the arrival jitter of data packets received from the peer gateway.

22. A method as recited in claim 21, further comprising having the receiving gateway monitor the amount of remaining data to modulate toward the receiving facsimile equipment.

23. A method as recited in claim 22, wherein the step of having the receiving gateway start transmission of HDLC flags immediately following the end of a HDLC frame and prior to transmission of the next frame, further comprises having the receiving gateway start transmission of HDLC flags once the amount of the remaining data in the buffer is below a pre-determined threshold and the receiving gateway has already transmitted the data portion of a scan line toward the receiving facsimile equipment.

24. A method as recited in claim 19, further comprising having the receiving gateway continue transmission of HDLC flags until the maximum transmission of HDL flags is less than a pre-determined time period.

25. A method as recited in claim 19, further comprising having the receiving gateway continue transmission of HDLC flags until the maximum transmission of fill bits is less than a pre-determined time period and the amount of remaining data in the buffer is below a pre-determined threshold.

26. A receiving gateway configured to improve fax quality when transmitting fax over a packet based network, wherein the packet based network includes receiving facsimile equipment in communication with the receiving gateway, said receiving gateway configured to store received demodulated data from the network in a buffer, monitor a state of a fax relay protocol, decode the demodulated data, at least one of identify the location of an End Of Line (EOL) sequence within the buffer and identify the location of inter-frame HDLC flags, and at least one of start transmission of a “Fill” immediately after the end of a scan line and prior to transmission of EOL and start transmission of HDLC flags immediately following the end of a HDLC frame and prior to transmission of the next frame.

27. A receiving gateway as recited in claim 26, wherein the receiving gateway is configured to transmit demodulated data to the receiving facsimile equipment in at least one of non-ECM mode and ECM mode.

28. A receiving gateway as recited in claim 26, wherein the network includes a peer gateway in communication with the receiving gateway, and wherein the receiving gateway is configured to monitor the arrival jitter of data packets received from the peer gateway.

29. A receiving gateway as recited in claim 28, wherein the receiving gateway is configured to monitor the amount of remaining data to modulate toward the receiving facsimile equipment.

30. A receiving gateway as recited in claim 26, wherein the receiving gateway is configured to start transmission of the “Fill” once the amount of the remaining data in the buffer is below a pre-determined threshold and the receiving gateway has already transmitted the data portion of a scan line toward the receiving facsimile equipment.

31. A receiving gateway as recited in claim 26, wherein the receiving gateway is configured to continue transmission of“Fill” until the maximum transmission of fill bits is less than a pre-determined time period.

32. A receiving gateway as recited in claim 26, wherein the receiving gateway is configured to continue transmission of“Fill” until the maximum transmission of fill bits is less than a pre-determined time period and the amount of remaining data in the buffer is below a pre-determined threshold.

33. A receiving gateway as recited in claim 26, wherein the receiving gateway is configured to start transmission of HDLC flags immediately following the end of a HDLC frame and prior to transmission of the next frame, further comprises having the receiving gateway start transmission of HDLC flags once the amount of the remaining data in the buffer is below a pre-determined threshold and the receiving gateway has already transmitted the data portion of a scan line toward the receiving facsimile equipment.

34. A receiving gateway as recited in claim 26, wherein the receiving gateway is configured to continue transmission of HDLC flags until the maximum transmission of HDL flags is less than a pre-determined time period.

35. A receiving gateway as recited in claim 26, wherein the receiving gateway is configured to continue transmission of HDLC flags until the maximum transmission of fill bits is less than a pre-determined time period and the amount of remaining data in the buffer is below a pre-determined threshold.

36. A packet based network configured to improve fax quality when transmitting fax, said packet based network comprising receiving facsimile equipment and a receiving gateway in communication with the receiving facsimile equipment, said receiving gateway configured to store received demodulated data from the network in a buffer, monitor a state of a fax relay protocol, decode the demodulated data, at least one of identify the location of an End Of Line (EOL) sequence within the buffer and identify the location of inter-frame HDLC flags, and at least one of start transmission of a “Fill” immediately after the end of a scan line and prior to transmission of EOL and start transmission of HDLC flags immediately following the end of a HDLC frame and prior to transmission of the next frame.

37. A packet based network as recited in claim 36, wherein the receiving gateway is configured to transmit demodulated data to the receiving facsimile equipment in at least one of non-ECM mode and ECM mode.

38. A packet based network as recited in claim 36, further comprising a peer gateway in communication with the receiving gateway, and wherein the receiving gateway is configured to monitor the arrival jitter of data packets received from the peer gateway.

39. A packet based network as recited in claim 38, wherein the receiving gateway is configured to monitor the amount of remaining data to modulate toward the receiving facsimile equipment.

40. A packet based network as recited in claim 36, wherein the receiving gateway is configured to start transmission of the “Fill” once the amount of the remaining data in the buffer is below a pre-determined threshold and the receiving gateway has already transmitted the data portion of a scan line toward the receiving facsimile equipment.

41. A packet based network as recited in claim 36, wherein the receiving gateway is configured to continue transmission of “Fill” until the maximum transmission of fill bits is less than a pre-determined time period.

42. A packet based network as recited in claim 36, wherein the receiving gateway is configured to continue transmission of “Fill” until the maximum transmission of fill bits is less than a pre-determined time period and the amount of remaining data in the buffer is below a pre-determined threshold.

43. A packet based network as recited in claim 36, wherein the receiving gateway is configured to start transmission of HDLC flags immediately following the end of a HDLC frame and prior to transmission of the next frame, further comprises having the receiving gateway start transmission of HDLC flags once the amount of the remaining data in the buffer is below a pre-determined threshold and the receiving gateway has already transmitted the data portion of a scan line toward the receiving facsimile equipment.

44. A packet based network as recited in claim 36, wherein the receiving gateway is configured to continue transmission of HDLC flags until the maximum transmission of HDL flags is less than a pre-determined time period.

45. A packet based network as recited in claim 36, wherein the receiving gateway is configured to continue transmission of HDLC flags until the maximum transmission of fill bits is less than a pre-determined time period and the amount of remaining data in the buffer is below a pre-determined threshold.
